(19) United States
(12) Patent Application Publication
(10) Pub. No.: US 2015/0077321 A1
(43) Pub. Date: Mar. 19, 2015

(54) AUTO-STEREOSCOPIC DISPLAY DEVICE AND DRIVE METHOD

(71) Applicant: KONINKLIJKE PHILIPS N.V., EINDHOVEN (NL)

(72) Inventors: Christiaan Varekamp, Eindhoven (NL); Karel Johannes Gerhardus Hinnen, Eindhoven (NL); Marcus Theodorus Maria Lambooij, Eindhoven (NL)

(73) Assignee: KONINKLIJKE PHILIPS N.V., EINDHOVEN (NL)

(21) Appl. No.: 14/396,796

(22) PCT Filed: Apr. 16, 2013
(86) PCT No.: PCT/IB13/53020

§ 371 Date: Oct. 24, 2014

Related U.S. Application Data
(60) Provisional application No. 61/637,326, filed on Apr. 24, 2012.

(51) Int. Cl. G09G 3/34; G09G 3/36; H04N 13/04

(52) U.S. Cl. CPC G09G 3/3406; H04N 13/0402; H04N 13/0468; G09G 3/3611
USPC 345/102

(57) ABSTRACT

An auto-stereoscopic display uses a steering backlight to enable individual views to be directed to desired locations corresponding to the position of the eyes of a viewer. However, a single (i.e. monoscopic) image is provided at large angles where the quality of an auto-stereoscopic image may drop below acceptable levels. This is achieved by addressing the light sources in the steering backlight as a function of angle.

### FIELD OF THE INVENTION

This invention relates to auto-stereoscopic display devices.

### BACKGROUND OF THE INVENTION

Various types of auto-stereoscopic display devices are known. Essentially, such displays include an optical arrangement which directs different views into different directions at which the eyes of a user may be located, so that the user does not need to wear special glasses for this purpose.

The different directions of the views can for example be achieved with a lens arrangement, with individual lenses covering groups of pixels. The lenses then direct light from different pixels in different directions, and in this way different images (e.g. left and right) can be sent to different directions.

Another approach is to use a barrier arrangement. This again has the function of limiting the direction in which light from individual pixels can be sent.

A problem with these arrangements is that the resolution of the individual views is reduced. By operating in a time-multiplex as well as a spatial-multiplex manner, increased resolution can be obtained.

The designs outlined above provide the different views in fixed different directions. However, other designs provide tracking of the position of the eyes of one or more viewers. This means that for each viewer only two views need to be generated, instead of a full set of views (typically 9 or 15) filling the field of view.

This invention is particularly concerned with a known type of auto-stereoscopic display in which a light-steering backlight is used to direct light into the eyes of one or multiple viewers that are detected using cameras. The left- and right-images are displayed sequentially on an LCD.

For each viewer, two directional light source configurations of the backlight are switched on and off in phase with the LCD such that at a given moment in time each eye sees either the correct image or a black screen.

A light-steering backlight can for example comprise a pixellated backlight and a lens arrangement. By controlling the backlight elements which are illuminated, the resulting light output direction is determined by the lens. Electrowetting prism arrays can also be provided for directing a backlight output in different directions.

Typically, a lens array is used to achieve the required light-steering. However, these lens arrays suffer from aberrations off-axis. In particular, lens performance degrades as a function of incidence angle due to monochromatic aberrations such as coma (comatic aberration) and field curvature. This incidence angle dependent lens performance degradation has consequences for the design of auto-stereoscopic displays. For example loss of angular resolution occurs at larger incidence angles. This is a problem with backlight-steering approaches generally.

In practice this means that, due to optical aberrations, a viewer that is seated close to the normal of the display perceives stereo scenery with good (3D) quality, whereas viewers further off-axis from the normal perceive high amounts of crosstalk, inhomogeneous light or both. This situation is problematic for a product.

This invention is directed to the problem that the increased aberrations such as crosstalk and/or inhomogeneous light on the display for larger off-axis viewing angles can make the system unsuitable for a product.

### SUMMARY OF THE INVENTION

According to the invention there is provided a device and method as claimed in the independent claims.

According to one aspect of the invention, there is provided an auto-stereoscopic display device comprising:
a backlight arrangement which provides a light output in a direction which can be controlled,
a light modulating display panel illuminated by the backlight arrangement;
a head or eye tracking arrangement for tracking the position of a viewer; and
a controller for controlling the backlight arrangement and the display panel,
wherein the controller is adapted to control the backlight arrangement and display panel to provide directional control depending on a viewer position of left and right images in sequence to the two eyes of a viewer in a central display output zone, and to provide a single image without viewer-dependent directional control to lateral display output zones.

This arrangement uses a steering backlight to enable individual views to be directed to desired locations corresponding to the position of the eyes of a viewer. However, a single (i.e. monoscopic) image is provided at large angles where the quality of an auto-stereoscopic image may drop below acceptable levels. This is achieved by addressing the light sources in the steering backlight as a function of angle.

The backlight arrangement for example comprises a lens arrangement, and the display device of the invention avoids large viewing angle problems associated with the lens arrangement. For example, the backlight arrangement can comprise a segmented backlight; and the lens arrangement, wherein the lens arrangement comprises an array of lens units, wherein a respective sub-array of backlight segments is associated with each lens unit of the lens arrangement, such that the lens unit directs light output from associated backlight segments in specific directions. However, the invention can be applied to light steering backlights generally.

The controller is preferably adapted to provide the two images in sequence in a first and second sub-frame, and to provide the single image without viewer-dependent directional control to the lateral display output zones in only one of the sub-frames. The two images can be repeated at a higher repetition rate and at half the intensity, to reduce flickering if desired.

By displaying the single image in only one (or half) of the sub-frames, this means that the light intensity is comparable for the stereoscopic and monoscopic view areas of the display output—in that each eye receives an image during only one out of every two sub-frames.

A left image without viewer-dependent directional control can be provided to a left lateral display output zone in one of the sub-frames and a right image without viewer-dependent directional control can be provided to a right lateral display output zone in the other of the sub-frames. This avoids anti-stereo images at the boundary between the central and lateral viewing zones.

Each sub-array of backlight segments can comprise a segmented part for a region of the sub-array for providing light to the central display output zone, and non-segmented parts for the two the regions of the sub-array for providing light to the two lateral display output zones. This aspect recognises that a segmented backlight is not needed for the parts of the backlight sub-array which are for illuminating the single image lateral zones.

The non-segmented part on one side of one backlight sub-array can be shared with the non-segmented part on the other side of an adjacent backlight sub-array. This means the overall number of backlight segments can be kept to a minimum.

The controller can be further adapted to control the backlight arrangement and display panel to provide a single image without viewer-dependent directional control if the viewer is outside a predefined distance from the display panel. This aspect recognises that the auto-stereoscopic image quality also depends on viewing distance, so that the display can provide single view operation for viewing distances where the auto-stereoscopic image quality may not be adequate. The predefined range of suitable viewing distances can have a minimum range and a maximum range, since the ability to display auto-stereoscopic images deteriorates for small viewing distances and large viewing distances.

The angular size of the central display output zone can be adjustable by a viewer. The viewer can thus select the desired compromise between freedom of movement and optical aberrations and cross talk.

The invention also provides a method of controlling an auto-stereoscopic display device comprising a backlight arrangement which provides a light output in a direction which can be controlled and a light modulating display panel, wherein the method comprises:
detecting the position of at least one viewer in a field of view of the display device;
for a viewer in a central display output zone, controlling the backlight arrangement and display panel to provide directional control depending on the viewer position, and providing left and right images in sequence to the two eyes of the viewer; and
providing a single image without viewer-dependent directional control to lateral display output zones.

### BRIEF DESCRIPTION OF THE DRAWINGS

Examples of the invention will now be described in detail, with reference to the accompanying drawings, in which:

FIG. 1 is used to explain the basic operation of a known backlight steering auto-stereoscopic display device;

FIG. 2 shows a first example of components of an auto-stereoscopic display device of the invention;

FIG. 3 shows the two sub-frames for the display of FIG. 2;

FIG. 4 shows a second example of components of an auto-stereoscopic display device of the invention with a variable size stereoscopic region;

FIG. 5 shows a third example of components of an auto-stereoscopic display device of the invention;

FIG. 6(a) shows a further example of components of an auto-stereoscopic display device of the invention in which a viewing zone is defined, and FIG. 6(b) shows an alternative shape of viewing zone; and

FIG. 7 shows an auto-stereoscopic display device of the invention.

### DETAILED DESCRIPTION OF THE EMBODIMENTS

The invention provides an auto-stereoscopic display which uses a steering backlight to enable individual views to be directed to desired locations corresponding to the position of the eyes of a viewer. However, a single (i.e. monoscopic) image is provided at large angles where the quality of an auto-stereoscopic image may drop below acceptable levels. This is achieved by addressing the light sources in the steering backlight as a function of angle.

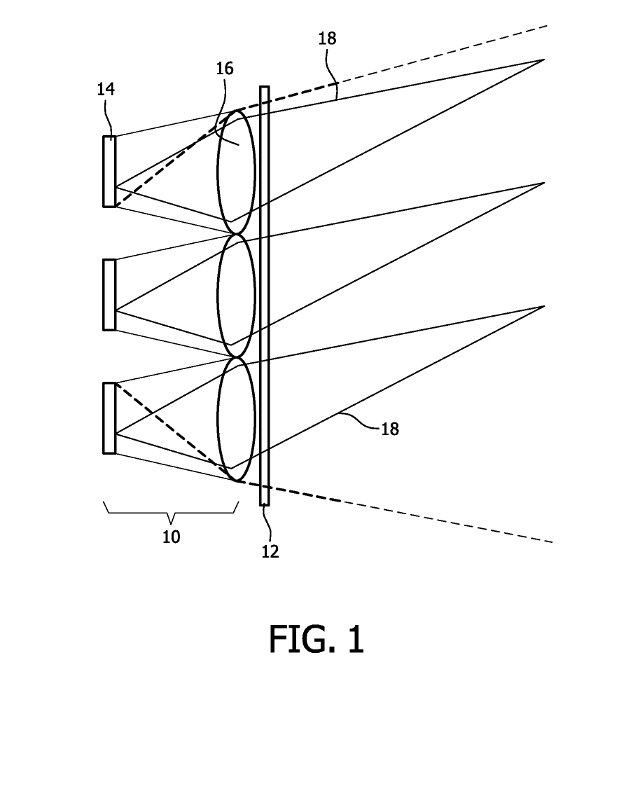

FIG. 1 is used to explain generally the type of display device to which the invention relates.

The display comprises a backlight arrangement 10 and a light modulating display panel 12, such as an LC panel. The backlight arrangement comprises a set of segmented backlight sub-arrays 14, each of which is associated with an output lens 16.

The more backlight sub-arrays there are, the greater the number of backlight segments that can be turned on to provide illumination of the display panel, so that the intensity of the individual backlight segments can be reduced. Of course, a greater number of backlight arrays implies a more complicated structure as well as higher cost as a result of the greater number of light sources. The size of the backlight sub-array is sufficient to enable a desired number of individually addressable backlight segments (e.g. individual LEDs) to be provided so as to give the desired controllability of the illumination direction. Thus, a compromise is found between the size of the individual lighting segments, the number of lighting segments per sub-array and the required backlight intensity per segment.

The limiting factor is typically the size of a single controllable light segment in the backlight sub-array. For a given viewing distance, a given angular resolution of view directions will be required, and this in turn specifies the angular resolution of the light source array, which relates to the size and spatial resolution of the light sources and lenses.

Each sub-array has a grid of light sources, such as LEDs. By selecting which LEDs are illuminated, the light output direction from the lenses can be controlled. As shown in FIG. 1, by using a selected LED within each sub-array, the light output direction from each lens is the same, as shown by envelopes 18. By suitable selection of one or more light sources in each sub-array 14 for each lens 16, the envelopes 18 can converge so that they meet at a single eye position for a designed viewing distance. Thus, by controlling the sub-arrays, the light output can be directed to specific lateral (i.e. left-right) position in space at a given viewing distance. A problem with this type of arrangement is that optical aberrations affect the light output for large off-axis exit angles.

The invention also uses backlight sub-arrays, but uses these to provide viewers with a monoscopic image at larger incidence angles. This is achieved by both spatially and temporally addressing the light sources in the steering backlight as a function of incidence angle. Since cross-talk levels can also depend on distance, it also possible to present viewers that are too close or too far from the display with monoscopic video.

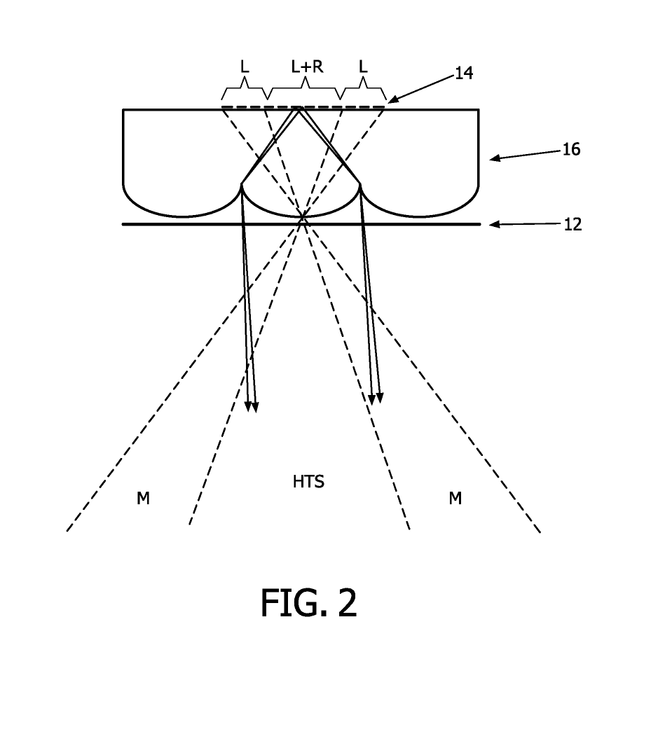

FIG. 2 shows an example of the display device of the invention. The basic structure is the same as in FIG. 1 and the same reference numerals are used. The invention relates specifically to the way the backlight sub-array 14 for each lens unit of the lens array 16 is controlled.

As shown in FIG. 2, a central part of the backlight sub-array provides illumination to a central display output zone. This zone is controlled in the same way as in the prior art, to provide a head tracked stereo area (HTS). Thus, within this zone, the position of a user is tracked and a left and right image are provided in sequence to the left and right eyes. Edge regions of the backlight sub-array 14 provide illumination to lateral display output zones. In accordance with the invention, these are single view monoscopic (M) areas. In the example of FIG. 2, the left eye image L is provided to both lateral output zones. Thus, a single image is provided without viewer-dependent directional control. Of course, the right image could instead be used for the monoscopic regions. A further alternative is to provide the left image to the left lateral side and a right image to the right lateral side, as discussed further below.

The central display output zone is a viewing region where monochromatic aberrations are not perceived by the viewer, and this is used as a stereoscopic region. Stereo content is only provided in this stereoscopic region where viewer's eyes are tracked. If in this stereoscopic region the viewer's eyes are detected at a specific incidence angle, light from different light sources is steered into the left eye and right eye by the lens optics.

The light sources corresponding to the left eye and right eye image are switched on and off alternately (indicated by L+R). Hence, the lens optics are static, but by dynamically addressing different light sources, viewers at different incidence angles in the stereoscopic region are provided with stereoscopic content. Light sources corresponding to incidence angles in this stereoscopic region at which no viewer's eyes are detected remain switched off.

This is the standard mode of operation.

At the larger incidence angles at which aberrations are perceived by the viewer, the viewer is provided with monoscopic content. These viewing regions are monoscopic regions and are at the left and right side of the stereoscopic region. In the example shown, all associated light sources of the backlight sub-array are switched on when the left-eye picture is displayed on the LCD and switched off when the right-eye picture is displayed on the LCD, independent of head/eye locations.

The LCD panel 12 may for example refresh at 240 Hz. In that case, the LCD displays the left-eye image for 1/120 s and the right-eye image for 1/120 s. In the stereoscopic region a viewer sees an image in the left eye and a black frame in the right eye alternated at 1/120 s with a black frame in the left eye and an image in the right eye. In the monoscopic region a viewer sees an image and a black frame alternated at 1/120 s with both eyes. In an undefined region laterally outside the monoscopic and stereoscopic areas, a viewer sees a black display mostly.

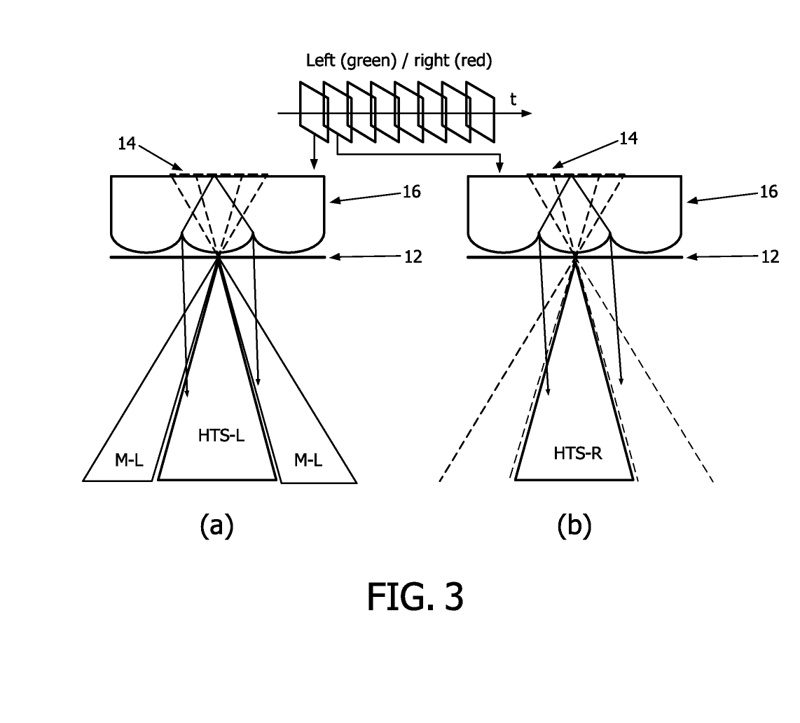

In the example where the left image is used to provide the monoscopic views, the left eye of viewers in the stereoscopic region and both eyes of viewers in the monoscopic region are served simultaneously. Thus, when the LCD panel displays the left stereo picture, the light sources corresponding to the monoscopic region and those serving the left eye of tracked viewers in the stereoscopic region are switched on simultaneously. This spatial and temporal multiplexing of left and right image is illustrated in FIG. 3, in which FIG. 3(a) shows the display of the left image content and FIG. 3(b) shows the display of right image content. These two display periods are thus sub-frames of the full image display.

Only during the left image display are the monoscopic regions illuminated, as represented by “M-L”, and the stereoscopic region displays to the left eye only, as represented by “HTS-L”. During the right image display only the stereoscopic region is illuminated with an image to the right eye only, as represented by “HTS-R”.

Using this approach, the brightness range perceived by a viewer in the monoscopic and stereoscopic region will be roughly the same.

When displaying the left picture in both monoscopic regions as shown, the viewer sees an anti-stereo transition when moving from the stereoscopic region to the right monoscopic region (anti-stereo refers to seeing a left image with the right eye and a right image with the left eye). This can be solved by partitioning the monoscopic regions such that the monoscopic area at the left of the stereoscopic region displays the left image and the monoscopic area at the right of the stereoscopic region displays the right image. It is not necessary to increase the display frame rate. Viewers in the left monoscopic region are served simultaneously with the left eyes in the stereoscopic region, while viewers in the right monoscopic region are served simultaneously with the right eyes in the stereoscopic region.

The size of the stereoscopic region is a trade-off between freedom of movement and cross-talk introduced by optic aberrations. Depending on the situation and viewer preferences, it may be desired to make a different choice. Assuming a given discretisation of the sources, the opening angles of the regions can be adjusted by assigning a number of light sources to regions of the backlight sub-array that are associated with the stereoscopic and monoscopic areas.

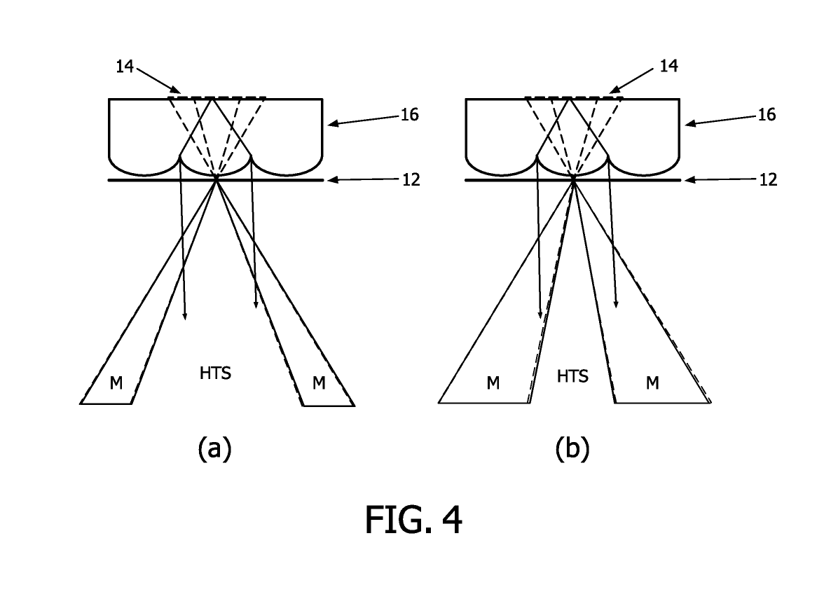

The preference can for instance be set via the remote control. FIG. 4 provides a schematic representation of this, in which FIG. 4(a) shows a larger central stereoscopic region (i.e. central display output zone) and FIG. 4(b) shows a smaller central stereoscopic region (i.e. central display output zone).

If the function of adjusting the size of the stereoscopic region is not needed, there is no need to have spatial segmentation of the light source to address the monoscopic regions. In other words, the light sources in the monoscopic regions can be grouped or replaced by a (single) larger light source. A physical field stop can be provided in the backlight structure that limits the maximum exit angle of the backlight. This reduces cross-talk.

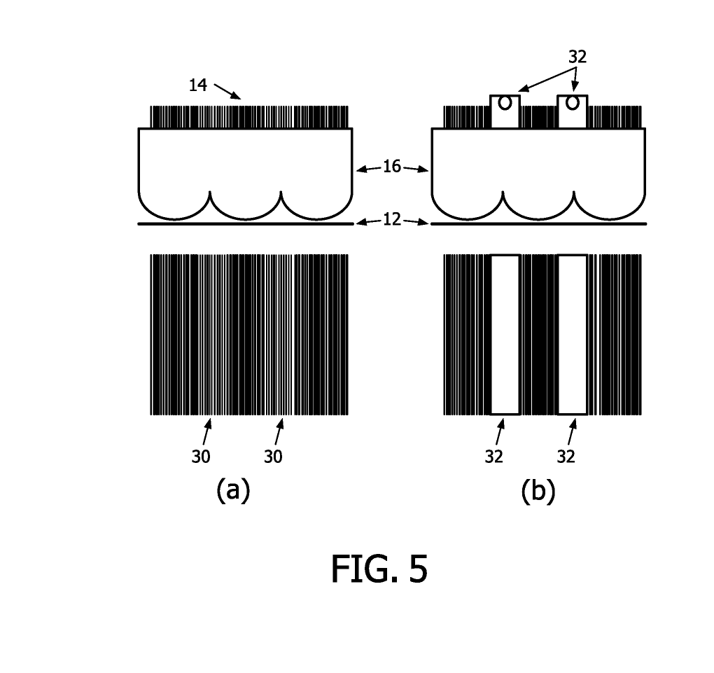

One embodiment of this idea is illustrated in FIG. 5.

FIG. 5(a) shows a fully segmented backlight sub-array 14, where certain regions 30 are used for illuminating the monoscopic areas. These regions are aligned with the edges of the lenses of the lens array 16.

FIG. 5(b) shows how the multiple light sources can be replaced by a more bulky single light source, such as LED 32. The single LED can be shared between the edge areas of two adjacent lenses as shown. If a left image is to be provided to the left lateral region and a right image is to be provided to a right lateral region, then each LED 32 needs a left part and a right part.

This use of larger backlight areas can lead to a cost reduction. For example, in the monoscopic regions, large LEDs with diffusers can be used as the light source.

The main principle of providing the viewer with good quality monoscopic images in viewing directions where cross-talk for stereo viewing become too severe, can be extended by including the viewing distance of the viewer. If the viewer is located too far from the screen, the spatial resolution of the backlight is too low to provide sufficient angular resolution for separating the left and right view. Hence, the cross-talk between the views increases with the viewing distance. When the viewer sits too close to the screen, part of screen is seen under a large exit angle. Also this will introduce optic distortions. Hence, a distance range can be defined in which the viewer has to be located in order to assure good stereo quality. Similar to the ideas presented above, it is possible to switch from a stereoscopic mode to a monoscopic mode when the viewer is not located within this distance range.

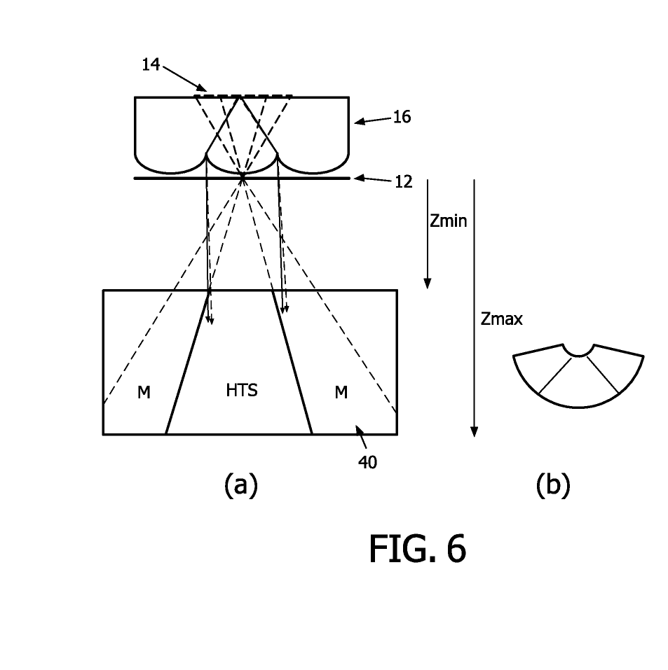

FIG. 6(a) shows a region 40 defined between upper and lower limits of the viewing distance: Zmax and Zmin. Only if a viewer is within this zone is the head tracked stereoscopic function activated.

Instead of defining a viewing zone based on distances along the axis direction as shown in FIG. 6(a), the viewing zone can be based on radial distances from a centre of the display screen. The viewing zone then becomes a segment of an annulus, between a minimum radial direction and a maximum radial direction. This is shown schematically in FIG. 6(b).

The switching between stereoscopic and monoscopic modes based on viewing distance is accomplished by actively adjusting the light sources dependent on head-tracking information, whereas the switching between stereoscopic and monoscopic modes based on the incidence angle is independent of viewer location.

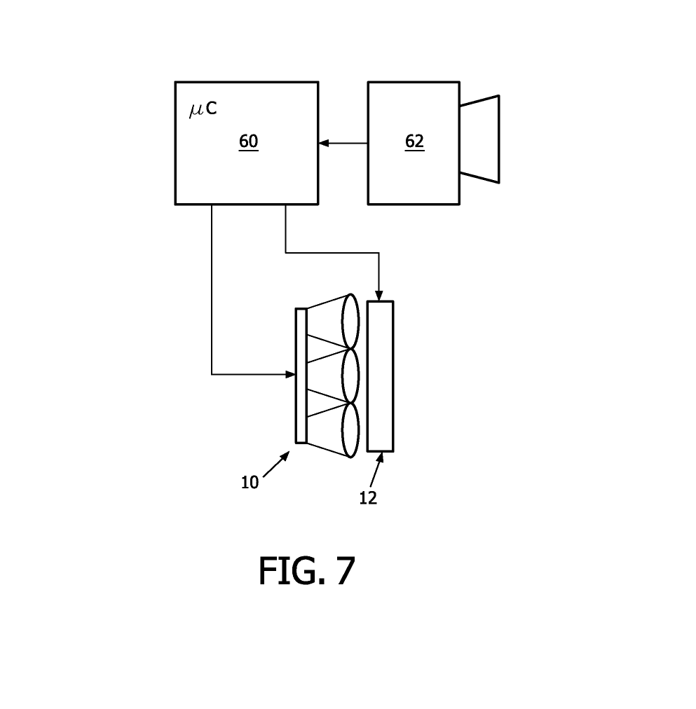

The complete system is shown in FIG. 7.

The backlight arrangement is shown as 10 for illuminating the display panel 12. A controller 60 receives an input from a head or eye tracking arrangement 62 which tracks the pupils of one or more viewers.

The controller 60 controls the display panel 12 to provide an output image for presentation to one pupil of one viewer. Each displayed image is thus a full resolution display at the native resolution of the display panel.

The different images required (two per viewer) are provided in a time sequential manner. For this purpose, the display panel has a high refresh rate, for example 120 Hz, 240 Hz or more.

The head tracking arrangement can comprise one or multiple cameras mounted on the display. The display panel can be an LCD panel or any other light modulating display technology.

The stereo head tracking system can track one or multiple viewers, and the stereoscopic images can be provided to multiple viewers at the same time, by suitable control of the backlight sub-arrays.

In the examples above, the switching between stereoscopic and monoscopic view is described as a discrete event, analogous to switching between two states. A more advanced approach can be to gradually reduce the depth and hence the difference between the left and right images at the transition between the stereoscopic viewing zone and the monoscopic viewing zone.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An auto-stereoscopic display device comprising:
a backlight arrangement (10) which provides a light output in a direction which can be controlled,
a light modulating display panel (12) illuminated by the backlight arrangement;
a head- or eye-tracking arrangement (62) for tracking the position of a viewer; and
a controller (60) for controlling the backlight arrangement and the display panel,
wherein the controller (60) is adapted to control the backlight arrangement and display panel to provide directional control depending on a viewer position of left and right images in sequence to the two eyes of a viewer in a central display output zone (HTS), and to provide a single image without viewer-dependent directional control to lateral display output zones (M).

2. A display as claimed in claim 1, wherein the backlight arrangement comprises a lens arrangement (16).

3. A display as claimed in claim 2, wherein the backlight arrangement comprises:
a segmented backlight; and
the lens arrangement (16),
wherein the lens arrangement comprises an array of lens units, and
wherein a respective sub-array (14) of backlight segments is associated with each lens unit of the lens arrangement, such that the lens unit directs light output from associated backlight segments in specific directions.

4. A device as claimed in claim 1, wherein the controller (60) is adapted to provide the two images in sequence in a first and second sub-frame, and to provide the single image without viewer-dependent directional control to the lateral display output zones in only one of the sub-frames.

5. A device as claimed in claim 1, wherein the controller (60) is adapted to provide the two images in sequence in a first and second sub-frame, and to provide a left image without viewer-dependent directional control to a left lateral display output zone in one of the sub-frames and to provide a right image without viewer-dependent directional control to a right lateral display output zone in the other of the sub-frames.

6. A device as claimed in claim 3, wherein each sub-array (14) of backlight segments comprises a segmented part for a region of the sub-array for providing light to the central display output zone, and a non-segmented part for the two regions of the sub-array for providing light to the two lateral display output zones.

7. A device as claimed in claim 6, wherein the non-segmented part on one side of one backlight sub-array is shared with the non-segmented part on the other side of an adjacent backlight sub-array.

8. A device as claimed in claim 1, wherein the controller is further adapted to control the backlight arrangement and display panel to provide a single image without viewer-dependent directional control if the viewer is outside a predefined distance range from the display panel.

9. A device as claimed in claim 6, wherein the predefined distance range has a minimum distance and a maximum distance.

10. A device as claimed in claim 1, wherein the angular size of the central display output zone is adjustable by a viewer.

11. A method of controlling an auto-stereoscopic display device comprising a backlight arrangement (10) which provides a light output in a direction which can be controlled and a light modulating display panel (12), wherein the method comprises the steps of:
detecting the position of at least one viewer in a field of view of the display device;
for a viewer in a central display output zone (HTS), controlling the backlight arrangement and display panel to provide directional control depending on the viewer position, and providing left and right images in sequence to the two eyes of the viewer; and
providing a single image without viewer-dependent directional control to lateral display output zones (M).

12. A method as claimed in claim 11, comprising providing the two images in sequence in a first and second sub-frame, and wherein the method comprises providing the single image without viewer-dependent directional control to the lateral display output zones in only one of the sub-frames.

13. A method as claimed in claim 11, comprising providing the two images in sequence in a first and second sub-frame, and to provide a left image without viewer-dependent directional control to a left lateral display output zone in one of the sub-frames and to provide a right image without viewer-dependent directional control to a right lateral display output zone in the other of the sub-frames.

14. A method as claimed in claim 11, comprising controlling the backlight arrangement and display panel to provide a single image without viewer-dependent directional control if the viewer is outside a predefined distance range from the display panel.

15. A method as claimed in claim 11, comprising receiving a user commend to set the angular size of the central display output zone, and controlling the backlight arrangement in dependence on the angular size setting.
